(19) United States
(12) Patent Application Publication
(10) Pub. No.: US 2006/0064529 A1
(43) Pub. Date: Mar. 23, 2006

(54) Method and system for controlling peripheral adapter interrupt frequency by transferring processor load information to the peripheral adapter

(75) Inventors: Vaijayanthimala K. Anand, Austin, TX (US); Janice Marie Girouard, Austin, TX (US); Emily Jane Ratliff, Austin, TX (US)

Correspondence Address: IBM CORPORATION (WM);C/O WEISS, MOY & HARRIS, P.C., 4204 NORTH BROWN AVENUE, SCOTTSDALE, AZ, 85251, US

(73) Assignee: International Business Machines Corporation, Armonk, NY (US)

(21) Appl. No.: 10/948,411

(22) Filed: Sep. 23, 2004

(51) Int. Cl. G06F 13/24

(52) U.S. Cl. 710/260

(57) ABSTRACT

A method and system for controlling interrupt frequency by transferring processor load information to a peripheral adapter provides adaptive interrupt latency to improve performance in a processing system. A device driver obtains current processor load information from an operating system or directly from processor usage counters. The estimated processor load is then used to set a parameter in the adapter that controls the frequency of an interrupt generator, which may be controlled by setting an interrupt queue depth threshold, packet frequency threshold or interrupt hold-off time value. The result is that the relative frequency of interrupts is managed in conformity with the current processor load, provide reduced processing latency when the system is relatively idle, which avoids loading the processor with additional interrupt processing overhead when the processor is busy.

### CROSS-REFERENCE TO RELATED APPLICATION

This application is related to co-pending U.S. patent application Ser. No. ______ filed concurrently with this application and entitled “METHOD AND APPARATUS FOR CONTROLLING PERIPHERAL ADAPTER INTERRUPT FREQUENCY BY ESTIMATING PROCESSOR LOAD IN THE PERIPHERAL ADAPTER”, by the same inventors and assigned to the same assignee. The specification of the above-referenced application is hereby incorporated by reference.

### BACKGROUND OF THE INVENTION

1. Technical Field

The present invention relates generally to interrupt-driven peripheral devices having input/output (I/O) queues, and more particularly, to a peripheral device that manages its interrupt frequency in conformity with processor load information received from the system.

2. Description of the Related Art

Peripheral devices connected to a processing system typically interrupt one or more processors in order to signal the presence of receive data or absence of transmit data in device queues. In the past, an interrupt was generally generated upon receipt of a complete packet or when a complete packet had been transmitted. When an interrupt is processed, the processes triggered by the interrupt generally transfer all of the data that is available in the receive queue and likewise flush the system transmit queues by transferring transmit data to the adapter. However, when the system is experiencing a large volume of traffic, the resulting increased frequency of the interrupts received can reduce system efficiency, compounding any backlog of processing activity. Network adapters in particular have a high traffic level in today's server system and the processing overhead for handling packets can be very high, especially in a web server where the packets require a response and are not merely forwarded after minimal processing, such as in routing applications.

To solve the above-described problem, a technique known as “interrupt coalescing” has been introduced, which lessens the frequency of interrupts directed at the processor(s). Rather than interrupt at each packet transfer, present-day adapters accumulate data in queues that can accommodate multiple packets and interrupts are triggered at a lower frequency. In particular, present network adapters typically accumulate a large amount of data before interrupting the processor managing data transfer between the adapter and the host system. In part, a large data size associated with each interrupt is provided due to the overhead associated with each interrupt.

Several interrupt timing schemes have been implemented for interrupt coalescing. Three primary techniques are presently used. The first technique times a hold-off time interval from receipt of the first new packet after the last interrupt. Upon expiration of the timer, the processor is interrupted. The first technique provides adaptability only in that an interrupt will be held off for the instantaneous time between the last interrupt and completion of the first packet plus the predetermined time. If the processor is not busy, the first technique introduces undesired latency. A second technique is to interrupt after a predetermined number of packets has been received (queue depth threshold). The second technique may generate an even higher latency, as no interrupt is generated until the required number of packets is received. A third technique generates an interrupt if the frequency of packets receives drops below a predetermined threshold (received packet frequency threshold).

Each of the above-described techniques reduces interrupt overhead in the system. However, none of the techniques takes into account the processor load. Therefore, undesirable latency can be introduced when the processor is not busy and the design values such as the timer length for the first technique above, the packet count for the second technique above and the threshold value for the third technique above may not be the ideal values for high load conditions at the processor, but merely a compromise between latency and reduced interrupt overhead.

Peripheral devices other than network adapters also introduce overhead when interrupting on a per-packet basis, and therefore interrupt coalescing techniques have also been used in storage systems adapters, bus adapters such as Fiber Channel, IEEE 1394 and Universal Serial Bus (USB) adapters, with the associated problems described above.

Therefore, it would be desirable to provide a method and system for managing peripheral device adapter interrupts to a processor and adapts to processor loading in order to reduce interrupt overhead while maintaining low latency.

### SUMMARY OF THE INVENTION

The objectives of providing for reduced interrupt overhead while maintaining low latency with respect to a peripheral device adapter is provided in a method and system.

The system includes a peripheral device adapter that adapts its interrupt frequency in conformity with processor load information transferred to the adapter, thereby providing an interrupt frequency that is dependent on processor load. The processor load information can be obtained from processor usage counters within the processing system that indicate current processor usage. The processor load information can then be used to set parameters for interrupt coalescing, such as an interrupt hold-off time, a queue depth threshold or a received packet frequency threshold.

The method of the present invention, or portions thereof may be embodied in a computer program product comprising program instructions for execution within a general or special-purpose processing system.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of an illustrative embodiment when read in conjunction with the accompanying drawings, wherein like reference numerals indicate like components, and:

FIG. 1 is a block diagram of a computing system in accordance with an embodiment of the present invention.

FIG. 2 is a block diagram showing details of network adapter 20 of FIG. 1.

FIG. 3 is a flowchart depicting a method in accordance with an embodiment of the present invention.

### DESCRIPTION OF ILLUSTRATIVE EMBODIMENT

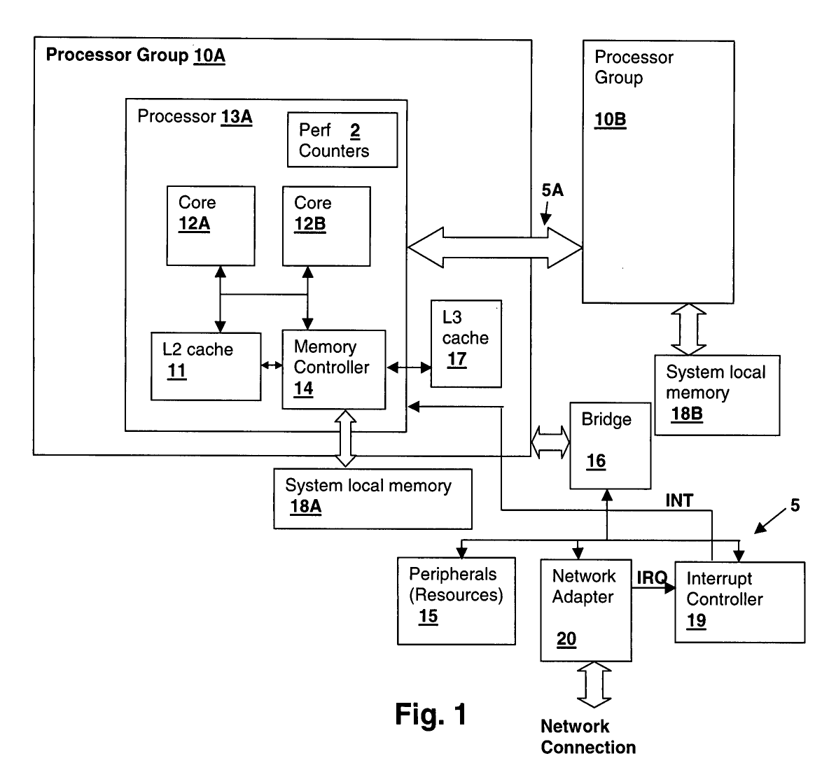

With reference now to the figures, and in particular with reference to FIG. 1, there is depicted a block diagram of a processing system in accordance with an embodiment of the present invention. It should be understood that the depicted embodiment is not intended to be limiting, but only exemplary of the type of processing system to which the methods and structures of the present invention may be applied. The system includes a processor group 10A having two cores 12A and 12B and coupled to another processor group 10B by a high-speed dedicated interface SA. Processor group 10A is connected to peripherals (hardware resources) 15 via a bridge 16. Cores 12A and 12B provide instruction execution and operation on data values for general-purpose processing functions, which include the processing of network data transfers between a network connection and processor group 10A via a network adapter 20. In particular, processor group 10A may be included in a web server providing web page files and other program code and data in response to web requests received over the network connection. Performance counters 2 are included to provide an operating system with information about processor load and other metrics within processor group 10A. The operating system transfers processor load information to the network adapter 20 in accordance with an embodiment of the present invention, whereby network adapter 20 adjusts its interrupt frequency in conformity with the processor load information. It should be noted that processor load information can be obtained by means other than hardware performance counters 2 using techniques such as software performance/processor usage counters that measure idle time slices to obtain processor load information or using other internal metrics to determine system processor activity.

Processor group 10A also includes an L3 cache unit 17, a shared L2 cache unit 11 and a memory controller 14. Each processor group 10A, 10B is coupled to separate associated local system memory 18A, 18B and can access any system memory via the various interconnections. However, to maintain low latencies, program instructions for execution by processor 13A are generally stored in system local memory 18A so that values from system local memory can be loaded into caches 11 and 17 as quickly as possible. Other global system memory may be coupled external to bridge 16 for symmetrical access by all processor groups.

PCI bus 5 couples the various peripherals 15, as well as an interrupt controller 19 to bridge 16. Bridge 16 is also coupled by bus 5 to network adapter 20, which includes circuits and implements methodologies in accordance with embodiments of the present invention. Interrupt controller 19 provides interrupt signals INT to processor group 10A and interrupts one of cores 12A or 12B within processor group 10A in response to an interrupt request signal IRQ provided by network adapter 20.

Within system local memory 18A and or 18B, a virtual machine monitor program, or “hypervisor” provides support for execution of multiple virtual machines (VMs) or “partitions” that each provide an execution environment for an operating system and a number of “guest” programs (applications and services executed by an operating system and running in the associated VM). However, the techniques of the present invention are equally applicable to single partition systems including uniprocessor systems and the illustrated system is provided only as an example of the technology to which the present invention may be applied. The hypervisor or other operating system, or alternatively a device driver providing a software interface to network adapter 20, includes program code that transfers a measure of processor load information to network adapter 20 so that network adapter 20 can then adjust its interrupt frequency.

The present invention concerns the operation of network adapter 20 and in particular a mechanism for managing a frequency of interrupts issued by network adapter 20 to processor group 10A. Network adapter 20 may be an Ethernet adapter, an ATM interface or other network interface. In general, the present invention applies to any peripheral adapter that coalesces interrupts and therefore the illustration with respect to network adapter 20 should not be construed as limiting the invention to network packet processing. Therefore, the term “packet” as used herein should be understood to apply to a single unit of data with respect to the peripheral device in which the invention is embodied and terms such as “block” or “sector” for other types of peripheral device adapters such as storage adapters should be understood to be encompassed by the term “packet”. Also, the term “frequency” as applied to the interrupt control of the present invention should not be construed as meaning absolute frequency of a fixed period, but rather a relative and average frequency at which interrupts occur, as may be triggered at asynchronous, synchronous or quasi-synchronous intervals by network adapter 20.

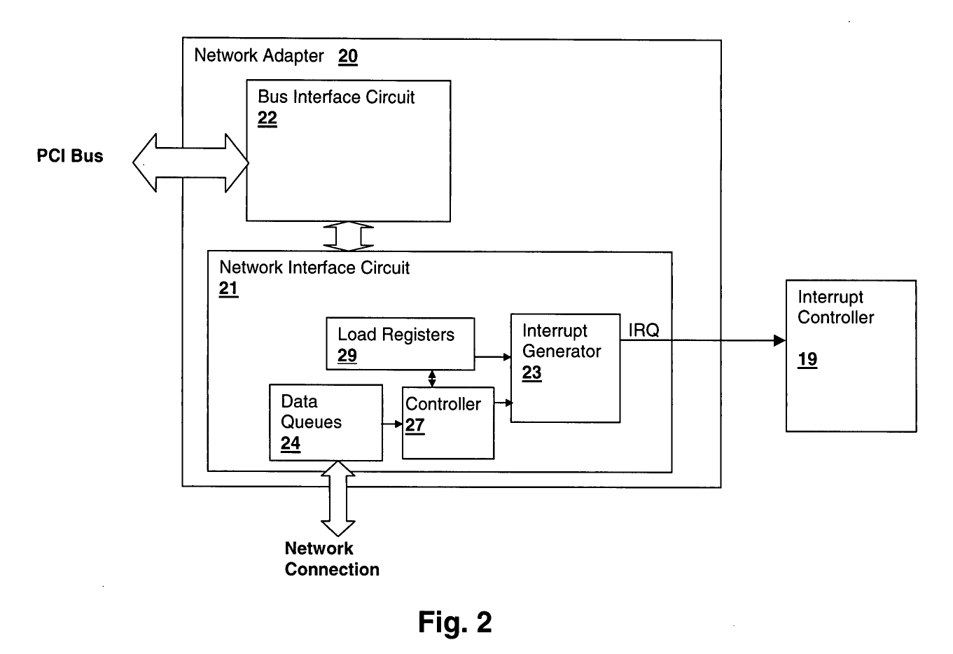

Referring now to FIG. 2, details of network adapter 20 and the configuration thereof are illustrated. Network adapter 20 includes a network interface circuit 21 that connects to the network connection and a bus interface circuit 22 that couples the network interface circuit 21 to external PCI bus 5. Network adapter provides an interrupt request signal IRQ to interrupt controller 19 and manages the frequency of the IRQ assertions in accordance with an embodiment of the present invention.

Within network interface circuit 21 a set of data queues 24 is managed by a controller 27 which may be a microprocessor or microcontroller or dedicated logic circuit that handles the transfer of data into and out of data queues 24 to bus interface circuit 22 and further provides an interrupt generator 23 with a signal indicating when to interrupt external processor group 10A. The present invention includes further input to interrupt generator 23 from load registers 29 so that the frequency of IRQ assertions can be tailored to the current processor load. When processor group 10A is busy processing network requests, the transmit data queue within data queues 24 will tend to starve, while the receive data queue will tend to fill up. It is under this condition that traditional interrupt coalescing methods can cause a downward spiral in performance, as the frequency of interrupts to the processor handling the network packets will be increased in order to attempt to keep up with the demand.

In the present invention, rather than rely solely on the frequency of packets received, the absolute depth of the receive queue, or the expiration of an interrupt time period, the present invention computes or receives a parameter corresponding to current processor load conditions and reduces the relative interrupt frequency in conformity with the processor load estimate. The parameter, or alternatively raw information from performance counters or operating-system based performance indicators is passed to load registers 29 (which may be locations in a memory within controller 27) by either direct programming of load registers 29 by the device driver managing network adapter 20 or by embedding the information in the transmit packet descriptors for packets sent by the processing system to network card 20 for transmission. The latter alternative provides that interrupt frequency control information is only updated when network activity is present, reducing any overhead associated with the interrupt frequency parameter determination when the system is not serving network traffic.

The interrupt frequency control parameter can be applied directly by the interrupt generator 23 or computed within network adapter 20 and normalized and mapped in a linear function to control interrupt frequency by adjusting a the parameter of the interrupt coalescing technique that is employed. The linear result may be used, for example, to control a timer value that times an interval from the first received packet after the last interrupt until the next interrupt, to control the receive queue depth at which an interrupt is issued, or to adjust a packet-frequency interrupt threshold. Normalizing of the processor load information can be performed in conformity with predetermined values, or via an averaging that observes performance counter trends to detect changes in processor load.

The linear mapping maps the processor load information to a parameter that controls the particular coalescing method employed by interrupt generator 23. For example, if the receive queue depth is the coalescing technique trigger and test results show that the interrupt overhead load on processor group 10A is effectively controlled by varying the receive queue depth interrupt threshold from 25% to 75%, and the range of the normalized processor load information is from 0 to 1, then the following formula may be employed:
Receive Queue Interrupt Threshold (%)=0.25+0.5*Normalized Processor load
which can then be multiplied by the queue size to yield a threshold in terms of the data size in the receive queue required for generating an interrupt. Similarly, a timed interrupt scheme can use the same scaling. For example if the interrupt time from the first packet received ranges from 10 μS to 100 μS in order to effectively control the interrupt overhead processor load, then the timer value can me computed as:
   Interrupt Timer Value (μS)=10+Normalized Processor Load×90

Finally, if the packet frequency of packets received by network adapter 20 is the control parameter and the interrupt overhead processor load can be effectively controlled by a threshold range of 1000 packets/sec to 100000 packets/sec, then the following formula may be employed:
Packet Frequency Interrupt Threshold (packets/Sec)=1000+Normalized Processor Load×99000

The present invention may further select among the above-described interrupt frequency control mechanisms as a function of the processor load. For example, it may be determined that through a range of processor load the packet frequency based control is preferable to the inter-interrupt timer mode. The optimum technique may be determined via calibration as mentioned above for the history determination, obtained via simulation or via systems testing. If the processor load information is used to select among the control mechanisms, controller 27 determines the mode from the value of the processor load information, selects the appropriate mechanism and programs interrupt generator 23 with both the mode and the parameter determined for the selected mode from one of the formulas given above.

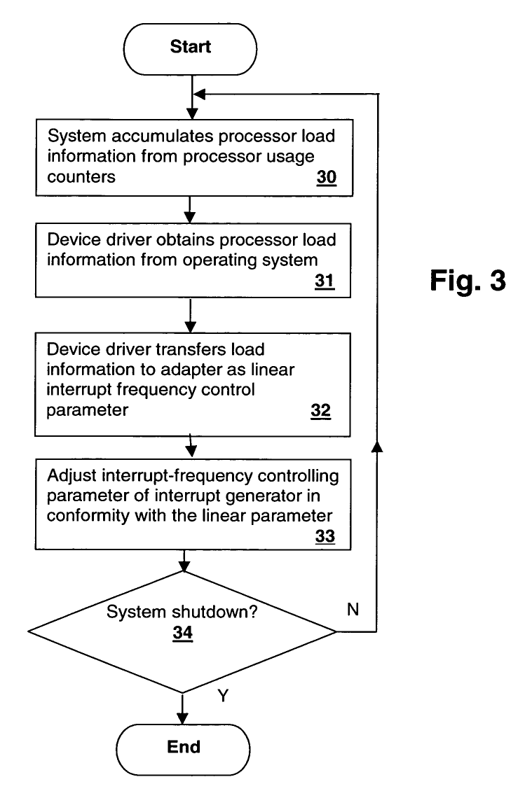

Referring now to FIG. 3, a method in accordance with an embodiment of the invention is depicted. First, the system accumulates processor load information either from hardware performance counters or software measurements (step 30). Next, the network adapter 20 device driver obtains the processor load information from the operating system (step 31). The device driver then transfers the processor load information as a linear interrupt frequency control parameter (step 32). Finally the interrupt-frequency controlling parameter of the interrupt generator is adjusted in conformity with the linear parameter (step 33). The process repeats until the system is shut down (decision 34).

While the invention has been particularly shown and described with reference to the preferred embodiment thereof, it will be understood by those skilled in the art that the foregoing and other changes in form, and details may be made therein without departing from the spirit and scope of the invention.

What is claimed is:

1. A method of controlling a frequency of interrupts issuing from a peripheral adapter in a processing system, said method comprising:
obtaining load information for a processor within said processing system;
computing a parameter of an interrupt control mechanism from said load information;
transferring information to said peripheral adapter corresponding to said load information; and
adjusting a frequency of interrupts issued by said adapter in conformity with said parameter within said adapter.

2. The method of claim 1, wherein said adapter is a network adapter.

3. The method of claim 1, wherein said transferring transfers said computed parameter to said adapter and wherein said computing is performed by said processor.

4. The method of claim 1, wherein said transferring transfers said load information to said adapter and wherein said computing is performed within said adapter.

5. The method of claim 1, wherein said obtaining obtains said load information from performance counters within said processing system.

6. The method of claim 1, wherein said obtaining obtains said load information from an operating system interface that provides said load information.

7. The method of claim 1, wherein said adjusting comprises adjusting a time interval and wherein said method further comprises:
in response to receipt of a first packet after a last interrupt, waiting a time corresponding to said time interval; and
generating a next interrupt in response to an end of said waiting at expiration of said time interval.

8. The method of claim 1, wherein said adjusting comprises adjusting a queue depth threshold and wherein said method further comprises:
determining whether or not a depth of a receive queue of said peripheral adapter exceeds said queue depth threshold, and
in response to determining that said depth of said receive queue exceeds said queue depth threshold, generating an interrupt.

9. The method of claim 1, wherein said adjusting comprises adjusting a packet frequency threshold and wherein said method further comprises:
measuring a frequency of packets received by said peripheral adapter;
determining whether or not said frequency exceeds said packet frequency threshold; and
in response to determining that said frequency exceeds said packet frequency threshold, generating an interrupt.

10. A processing system comprising:
a memory for storing program instructions and data;
a processor for executing said program instructions;
an interface for receiving a peripheral connection, wherein said interface is coupled to said processor for transferring packets between said processor and said peripheral connection, and wherein said interface has an interrupt output coupled to said processor for interrupting said processor, an interrupt generator coupled to said interrupt output for generating said interrupt, one or more data queues for storing data associated with a transfer between said peripheral connection and said external processor, and a control logic having an output coupled to said interrupt generator for controlling a frequency of interrupts generated by said interrupt generator in conformity with a programmed parameter, and wherein said program instructions comprise program instructions for:
obtaining load information for a processor within said processing system,
computing a parameter of an interrupt control mechanism from said load information,
transferring information to said interface corresponding to said load information, and
adjusting a frequency of interrupts issued by said interface by programming said interface with said parameter.

11. The processing system of claim 10, wherein said interface is a network interface.

12. The processing system of claim 10, wherein said program instructions for transferring transfer said computed parameter to said interface and wherein said computing is performed by said processor.

13. The processing system of claim 10, wherein said program instructions for transferring transfer said load information to said interface and wherein said program instructions for computing are located within a second memory located within said interface and executed by a second processor located within said interface, whereby said computing is performed within said interface.

14. The processing system of claim 10, wherein said program instructions for obtaining obtain said load information from performance counters within said processing system.

15. The processing system of claim 10, wherein said program instructions for obtaining obtain said load information from an operating system interface that provides said load information.

16. The processing system of claim 10, wherein said parameter is an inter-interrupt time interval and wherein said control logic waits a time corresponding to said time interval in response to receipt of a first packet after a last interrupt, and generates a next interrupt in response to an end of said waiting at expiration of said time interval.

17. The processing system of claim 10, wherein said parameter is a queue depth threshold and wherein said control logic determines whether or not a depth of a receive queue of said peripheral adapter exceeds said queue depth threshold, and in response to determining that said depth of said receive queue exceeds said queue depth threshold, generates an interrupt.

18. The processing system of claim 10, wherein said parameter is a packet frequency threshold and wherein said control logic measures a frequency of packets received by said peripheral adapter, determines whether or not said frequency exceeds said packet frequency threshold, and in response to determining that said frequency exceeds said packet frequency threshold, generates an interrupt.

19. A computer program product comprising signal-bearing media encoding program instructions for execution within a processing system, said processing system including at least a memory for storing said program instructions and data, a processor for executing said program instructions, and an interface for receiving a peripheral connection, wherein said interface is coupled to said processor for transferring packets between said processor and said peripheral connection, and wherein said interface has an interrupt output coupled to said processor for interrupting said processor, an interrupt generator coupled to said interrupt output for generating said interrupt, one or more data queues for storing data associated with a transfer between said peripheral connection and said external processor, and a control logic having an output coupled to said interrupt generator for controlling a frequency of interrupts generated by said interrupt generator in conformity with a programmed parameter, and wherein said program instructions comprise program instructions for:
obtaining load information for a processor within said processing system;
computing a parameter of an interrupt control mechanism from said load information;
transferring information to said interface corresponding to said load information; and
adjusting a frequency of interrupts issued by said interface by programming said interface with said parameter.

20. The computer program product of claim 19, wherein said program instructions comprise a device driver that manages said interface and wherein said program instructions for obtaining obtain said load information from an operating system executed by said processor.
